(19) United States
(12) Patent Application Publication
(10) Pub. No.: US 2015/0353402 A1
(43) Pub. Date: Dec. 10, 2015

(54) Water Treatment System

(71) Applicant: Dale Johnson, Pensacola, FL (US)

(72) Inventor: Dale Johnson, Pensacola, FL (US)

(21) Appl. No.: 14/300,468

(22) Filed: Jun. 10, 2014

(51) Int. Cl. C02F 9/00; C02F 1/32; C02F 1/72; C02F 1/461; C02F 1/78

(52) U.S. Cl. CPC C02F 9/005; C02F 1/46104; C02F 1/78; C02F 1/72; C02F 1/325; C02F 2001/46152; C02F 2303/04; C02F 2103/04

(57) ABSTRACT

A water treatment system is a portable in-line pass thru system can be directly attached to the suction or discharge side of a water pump. The water treatment system provides multiple treatment modalities to eradicate biological contaminants from a water source for use in industrial or municipal applications. The water treatment system is reconfigurable to treat a variety of water supplies containing different kinds of contaminants. The water treatment system uses multiple modalities to ensure a wide spectrum biocidal effect. The water treatment system accomplishes this through the use of a irradiation unit, an electrolysis unit, and at least one chemical injection unit. The combination of treatments used by the water treatment system can be specifically determined based on known contaminant constituents within the body of water to more effectively eliminate the unwanted contaminants.

The current application claims a priority to the U.S. Provisional Patent application Ser. No. 61/976,329 filed on Apr. 7, 2014.

### FIELD OF THE INVENTION

The present invention relates generally to water treatment systems. More specifically to a multistage water treatment system that utilizes multiple modalities to eradicate biological contaminants from a water source

### BACKGROUND OF THE INVENTION

Removal of contaminants from a water supply is a pervasive and continuous requirement. In industrial and municipal applications processes, it is necessary to treat large volumes of water. For industrial applications, Oil and gas companies, require large volumes of water that are pretreated with Biocides to reduce and or eliminate unwanted organisms. Unwanted organism such as bacteria can change the quantity of unwanted chemical compounds within a body of water which can result in unwanted wear to industrial machinery as well as unwanted reactions with during refining processes. In municipal applications, such as water treatment plant, water biocides are used to treat water in order to make it safe for human consumption. Untreated water may contain dangerous levels of organic matter than can make people sick or kill those with compromised immune systems. There are currently several contaminant removal systems in existence that include, filtration systems, coagulation systems, chemical treatment systems, aeration systems, electrolysis systems, and ultraviolet treatment systems, as well as combinations thereof, but many of these systems are not portable.

It is therefore the object of the present invention, to provide a portable water treatment system that functions as an in-line pass thru system that may be directly attached to the suction or discharge side of water pumps. The water treatment system provides multiple treatment modalities to eradicate biological contaminants from a water source for use in industrial or municipal applications. The water treatment system draws water from bodies containing contaminants such as frac water tanks, brackish well basins, retention ponds, water filtration reaction tanks, and dissolved air tanks. The water treatment system uses multiple modalities ensure a wide spectrum biocidal effect. The combination of treatments used by the water treatment system can be specifically determined based on known contaminant constituents within the body of water to more effectively eliminated the unwanted contaminants.

### BRIEF DESCRIPTIONS OF THE DRAWINGS

FIG. 1 is a perspective view displaying the water treatment system configured as per the current embodiment of the present invention.

FIG. 2 is a cross sectional view displaying the interior compartments of the water treatment system as per the current embodiment of the present invention.

FIG. 3 is an expanded view displaying the alignment of the irradiation stage, the electrolysis stage, and the chemical injection stage as per the current embodiment of the present invention.

FIG. 4 is a cross sectional view displaying the alignment of the interior compartments of the irradiation stage, the electrolysis stage, and the chemical injection stage as per the current embodiment of the present invention.

FIG. 5 is a front elevational view displaying the interior portion of the irradiation stage as per the current embodiment of the present invention.

FIG. 6 is a lateral elevational view displaying the internal positioning of the UV irradiation unit within the irradiation stage as per the current embodiment of the present invention.

FIG. 7 is a perspective view displaying the internal positioning of the UV irradiation unit within the irradiation stage as per the current embodiment of the present invention.

FIG. 8 is a front elevational view displaying the interior portion of the electrolysis stage as per the current embodiment of the present invention.

FIG. 9 is a lateral elevational view displaying the internal positioning of the electrolysis unit within the electrolysis stage as per the current embodiment of the present invention.

FIG. 10 is perspective view displaying the internal positioning of the electrolysis unit within the electrolysis stage as per the current embodiment of the present invention.

FIG. 11 is a rear elevational view displaying the internal positioning of the at least one chemical injection unit within the chemical injection stage as per the current embodiment of the present invention.

FIG. 12 is a lateral elevational view displaying the internal positioning of the at least one chemical injection unit within the chemical injection stage as per the current embodiment of the present invention.

FIG. 13 is a perspective view displaying the internal positioning of the at least one chemical injection unit within the chemical injection stage as per the current embodiment of the present invention.

### DETAIL DESCRIPTIONS OF THE INVENTION

All illustrations of the drawings are for the purpose of describing selected versions of the present invention and are not intended to limit the scope of the present invention.

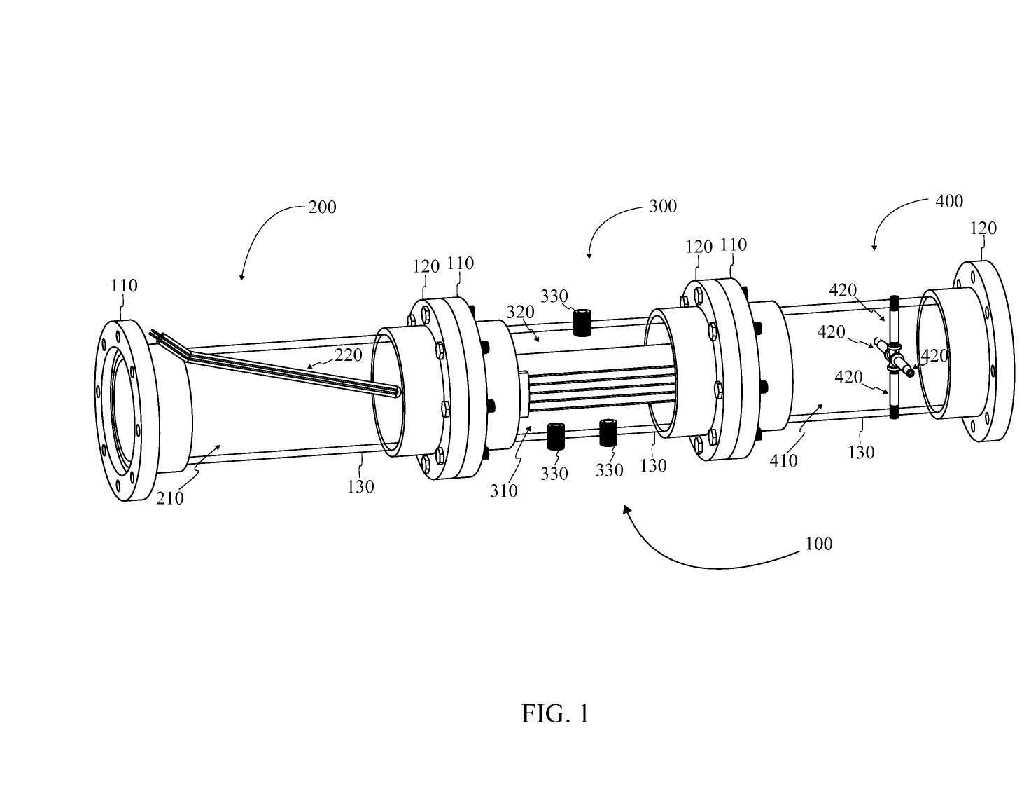

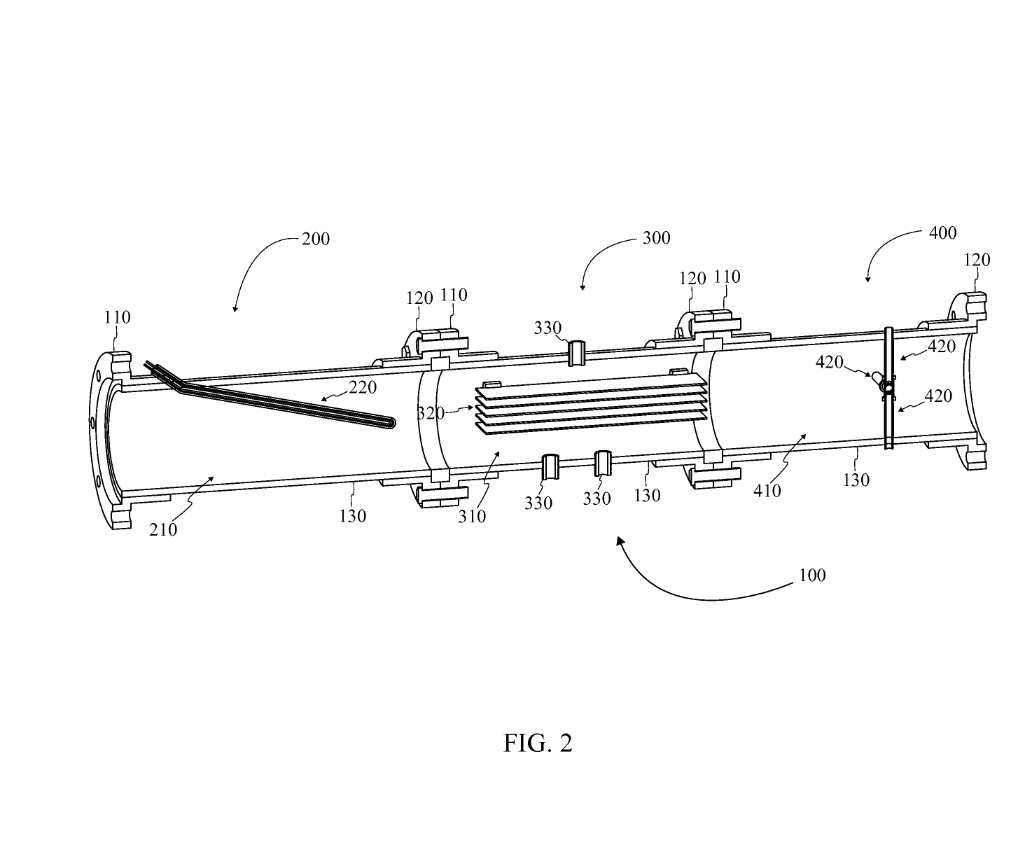

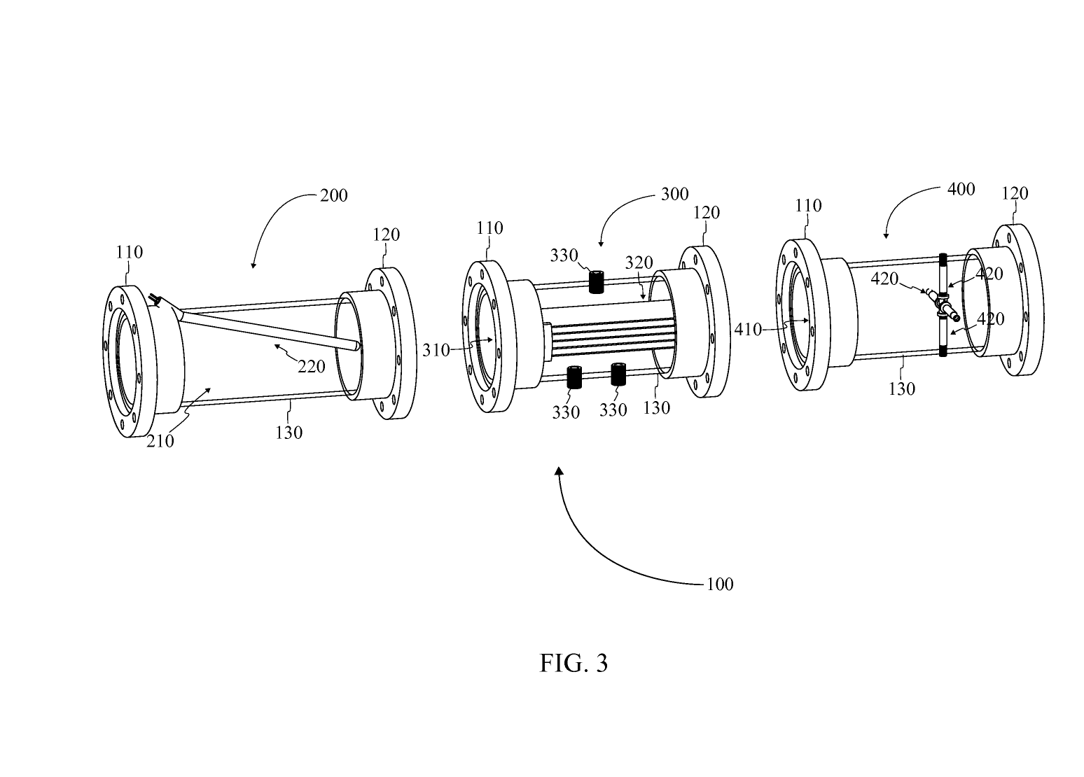

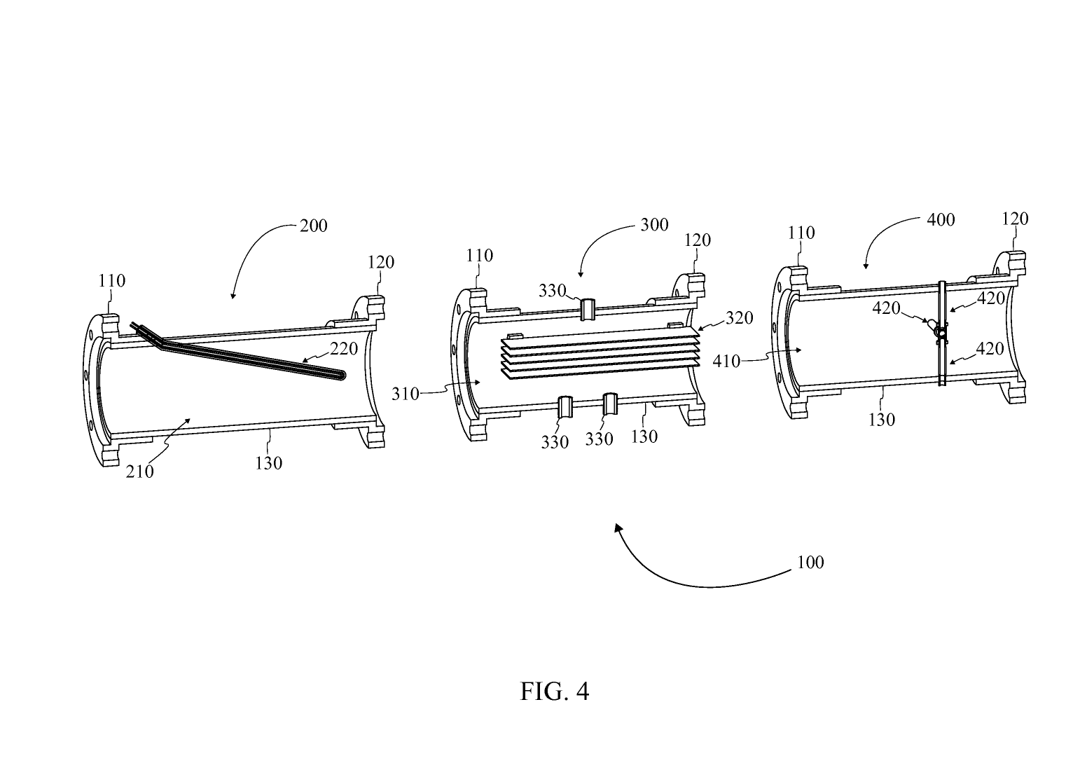

Referencing FIG. 1-4, the present invention is a pass through multistage water treatment system 100 that attaches to the inlet pipe or the exhaust pipe of a water pump. The water treatment system 100 provides multiple treatment modalities to eradicate biological contaminants from a water source for use in industrial or municipal applications. In the current embodiment of the present invention, the water treatment system 100 comprises an irradiation state, an electrolysis stage 300, and a chemical injection stage 400. Each stage of the water treatment system 100 provides a different treatment modality that in combination function complimentarily to one another improving the biocidal performance of the water treatment system 100. The irradiation stage 200 emits ultraviolet (UV) radiation onto the passing water flow exposing unwanted organisms to the biocidal effects of the UV wavelengths. The electrolysis stage 300 generates, chlorine gas, a biocidally active agent, in the passing water flow through electrolysis. The chemical injection stage 400 introduces chemical agents into the passing water flow that can function as biocidally active agents and/or enhance the effectiveness of the irradiation stage 200 and the electrolysis stage 300.

In an embodiment of the invention, the water treatment system 100 is in-line pass thru system that may be directly attached to the suction or discharge side of water pumps that draw from water bodies containing contaminants such as frac water tanks, brackish well basins, retention ponds, water filtration reaction tanks, and dissolved air tanks.

Referencing FIG. 1-4, the irradiation stage 200, the electrolysis stage 300, and the chemical injection stage 400 share similarities in their construction that accommodate attachment to an existing water pump system as well as facilitate reconfiguration of the stages to meet the needs of different water conditions. In the current embodiment of the present invention, the irradiation stage 200, the electrolysis stage 300, and the chemical injection stage 400 each comprise a first flanged end 110, a second flanged end 120, and a lateral wall 130. The first flanged end 110 and the second flanged end 120 are oppositely positioned terminal structures of each stage that permit a secure and water tight engagement between the stages as well as with the piping of an existing water pump. The first flanged end 110 and the second flanged end 120 are centrally aligned with the lateral wall 130. The central alignment permits the formation of a conduit through the first flanged end 110 and the second flanged end 120 in order to function as a flow passage for a particular stage of the water treatment system 100.

Referencing FIG. 1-4, the irradiation stage 200, the electrolysis stage 300, and the chemical injection stage 400 are centrally aligned to each other. The central alignment through the stages provides a direct path for water to pass through the water treatment system 100 on its way to or flowing out of an existing water pump. The irradiation stage 200, the electrolysis stage 300, and the chemical injection stage 400 each comprise an associated flow passage that serves as the fluid conduit through which water passes through. The associated flow passage of the irradiation stage 200, electrolysis stage 300, and the chemical injection stage 400 are operatively aligned to each one another. The operative alignment provides that the water passing through an associated flow passage of the irradiation stage 200, the electrolysis stage 300, or the chemical injection stage 400 flows into another associated flow passage for additional treatment by the particular stage. The irradiation stage 200, the electrolysis stage 300, and the chemical injection stage 400 are detachably coupled to one another. The flanged ends of neighboring stages are detachable coupled to one another providing a means to replace, repair, or rearrange the stages as needed. The irradiation stage 200, the electrolysis stage 300, and the chemical injection stage 400 are sealed to one another. A water tight seal is formed between the coupled flanged ends of neighboring stages in order to prevent water from leaking out of the water treatment system 100 while water is passing through.

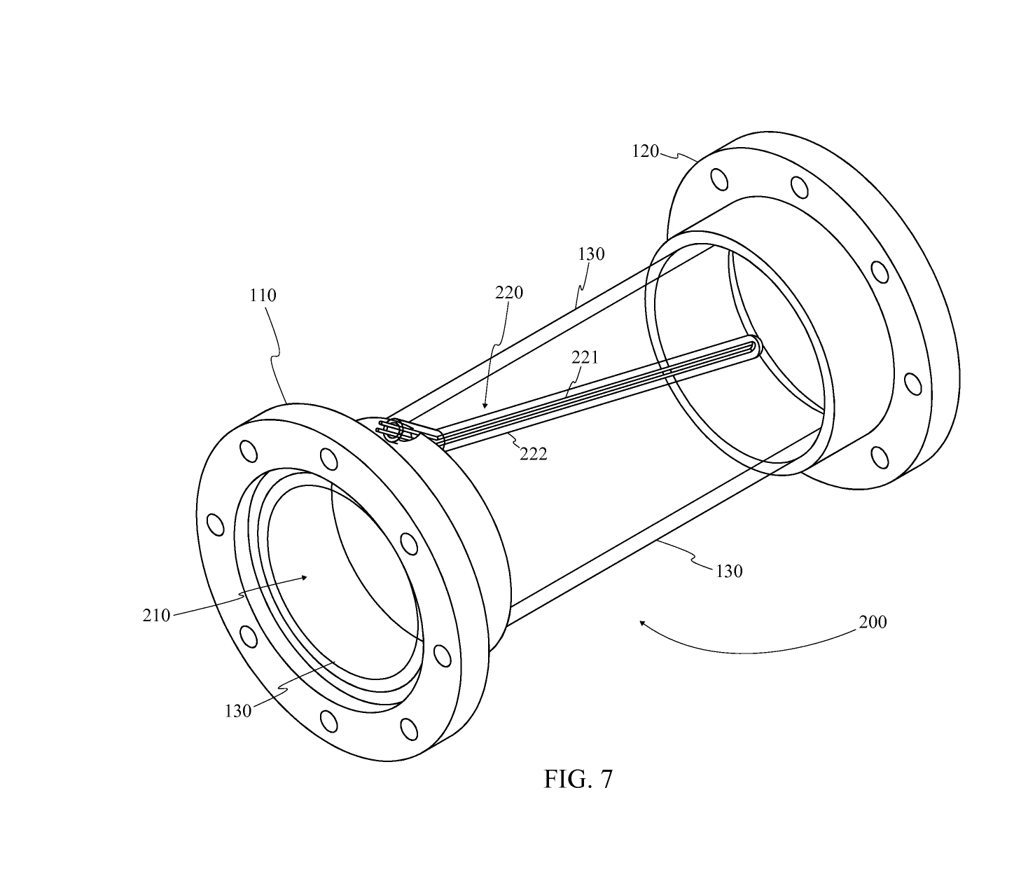

Referencing FIG. 1-4 and FIG. 5-7, the irradiation stage 200 utilizes UV radiation as its water treatment means. In the current embodiment of the present invention, the irradiation stage 200 comprises a first flanged end 110, a second flanged end 120, a lateral wall 130, a first flow passage 210, and an ultraviolet (UV) irradiation unit 220. The first flanged end 110 and the second flanged end 120 of the irradiation stage 200 are oppositely positioned to one another across the lateral wall 130 of the irradiation stage 200. Similar to the other stages, the first flanged end 110 and the second flanged end 120 of the irradiation stage 200 are centrally aligned with the lateral wall 130 of the irradiation stage 200. The first flow passage 210 is positioned along the central alignment forming a linear path for water to flow through. The first flow passage 210 is surrounded by the lateral wall 130 of the irradiation stage 200. The lateral wall 130 of the irradiation stage 200 functions as a barrier preventing transmission of UV wavelengths outside of the water treatment system 100. The first flow passage 210 is centrally positioned to the first flanged end 110 and the second flanged end 120 of the irradiation stage 200. The central positioning of the first flow passage 210 enables an operative alignment with the associated flow passage of another stage. The UV irradiation unit 220 is positioned between the first flanged end 110 and the second flanged end 120 of the irradiation stage 200. The UV irradiation unit 220 traverses into the first flow passage 210 through the lateral wall 130 of the irradiation stage 200. The irradiation unit 220 traverses the lateral wall 130 of the irradiation stage 200 proximal to the first flanged end 110 of the irradiation stage 200 and passes into the first flow passage 210 at an angle towards the second flanged end 120 of the irradiation stage 200. The traversal point of the UV irradiation unit 220 serves as a mounting point, securing the UV irradiation unit 220 to the lateral wall 130 of the irradiation stage 200. The UV irradiation unit 220 is optically disposed within the first flow passage 210, wherein the UV emitting components of the UV irradiation unit 220 are found positioned within the first flow passage 210. It should be noted that the lateral wall 130 of the irradiation unit 220 is constructed of an opaque material that functions as a barrier that is resistant to UV wavelengths, reducing transmission of UV radiation outside of the water treatment system 100.

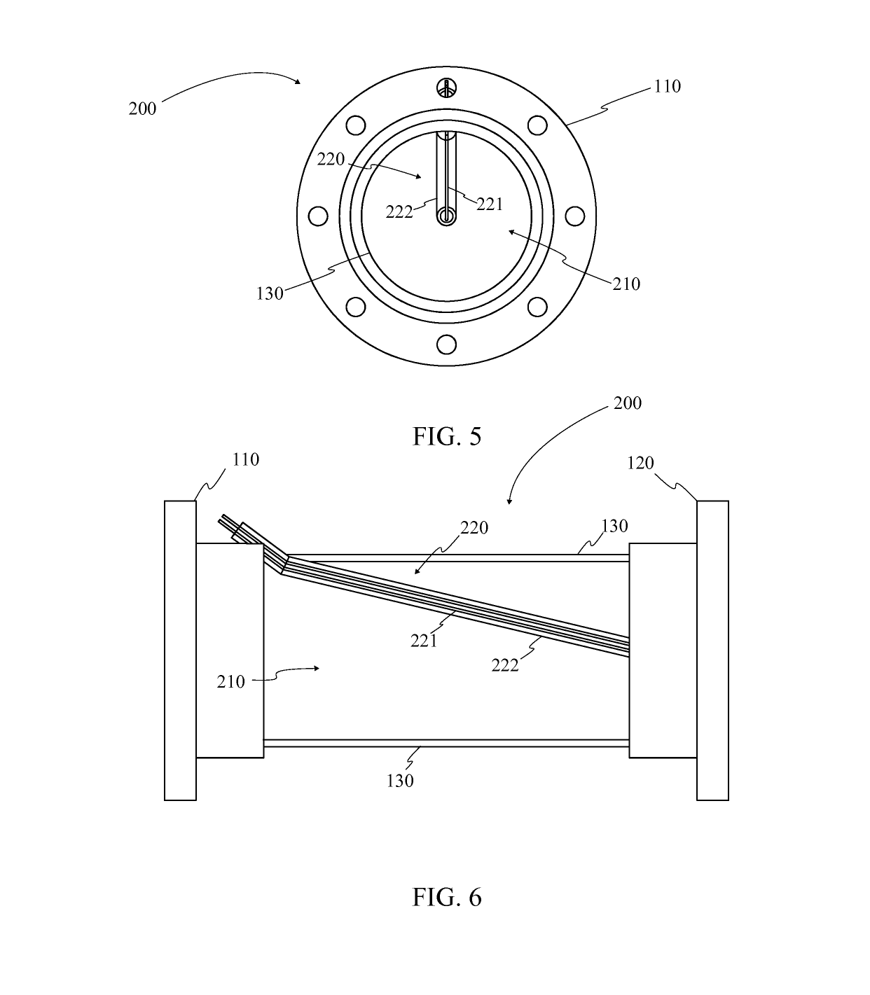

Referencing FIG. 5-7, the UV irradiation unit 220 is the functional component of the irradiation stage 200. The UV irradiation unit 220 is electrically powered and emits UV radiation as the means of treating water passing through the first flow passage 210. In the current embodiment of the present invention, the UV irradiation unit 220 comprises at least one ultraviolet (UV) bulb 221 and a transparent quartz enclosure 222. The transparent quartz enclosure 222 is an optical housing that is particularly suited for the transmission of UV wavelengths. The transparent quartz enclosure 222 is angularly positioned to the lateral wall 130 of the irradiation stage 200. The angular position places the transparent quartz enclosure 222 extending from a coincident point with the lateral wall 130 of the irradiation stage 200 near the first flanged end 110 of the irradiation stage 200 and extending centrally towards the second flanged end 120 of the irradiation stage 200. The angular positioning of the transparent quartz enclosure 222 prolongs exposure of the UV radiation to the flow of water passing through the first flow passage 210. The transparent quartz enclosure 222 surrounds the at least one UV bulb 221, protecting it from damaging effects of passing water flowing through the first flow passage 210. The at least one UV bulb 221 is the UV emitting elements that irradiates the passing water. The at least one UV bulb 221 is electrically powered by an external power source. The at least one UV bulb 221 emits lethal levels of UV radiation killing undesired organism while additionally providing the necessary energy for exciting chlorine ions dissolved within the passing water. Referencing FIG. 1-7, it should be noted that the irradiation stage 200 is longer than both the electrolysis stage 300 and the chemical injection stage 400. The irradiation stage 200 is provided as longer than the other stages in order to prolong the exposure of UV radiation in order to overcome any turbidity in the passing flow of water. In an embodiment of the invention the at least one UV bulb 221 is provided as an array of UV bulbs 221 enhancing the effectiveness of the UV irradiation unit 220. In the preferred embodiment of the invention, UV bulb 221 generates electromagnetic waves in the ultraviolet range between 400 nm nanometers and 10 nm nanometers. Furthermore the transparent quartz enclosure 222 is particularly configured to accommodate the particular wavelength range.

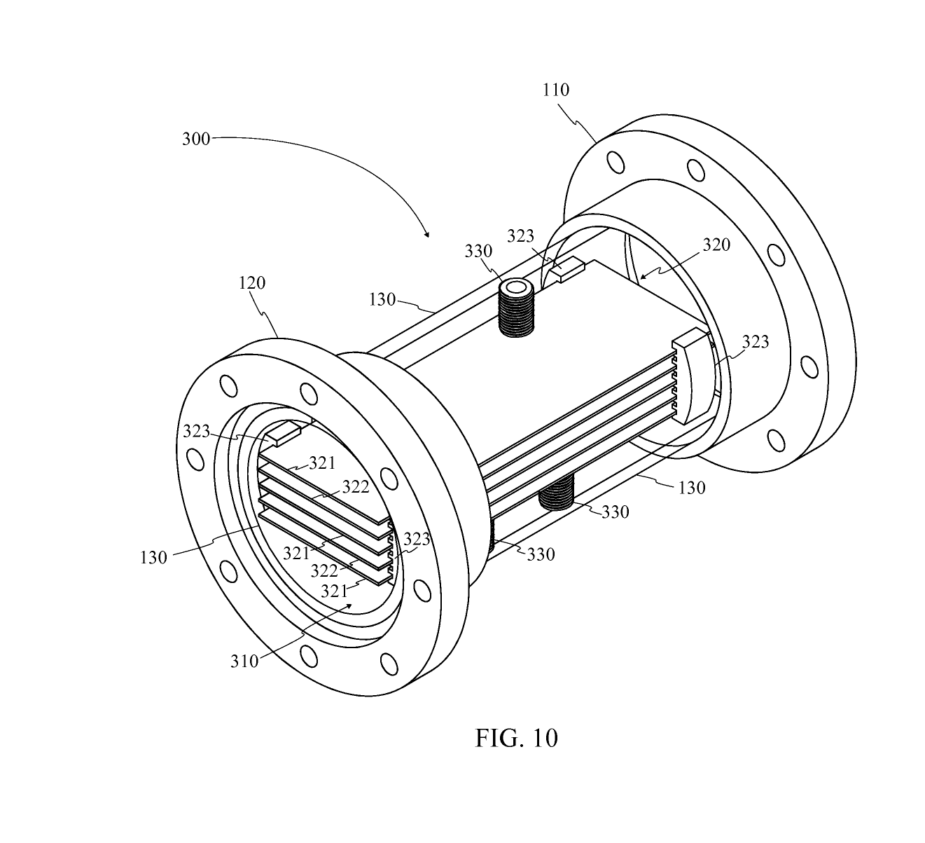

Referencing FIG. 1-4 and FIG. 8-10, the electrolysis stage 300 creates an electrical potential with an electrolysis unit 320 in order to generate chlorine gas as a biocidal active agent for treating the flow of water passing through the electrolysis stage 300. In the current embodiment of the present invention, the electrolysis stage 300 comprises a first flanged end 110, a second flanged end 120, a lateral wall 130, a second flow passage 310, and an electrolysis unit 320. The first flanged end 110 and the second flanged end 120 of the electrolysis stage 300 are oppositely positioned to one another across the lateral wall 130 of the electrolysis stage 300. Similar to the other stages, the first flanged end 110 and the second flanged end 120 of the electrolysis stage 300 are centrally aligned with the lateral wall 130 of the electrolysis stage 300. The second flow passage 310 is positioned along the central alignment forming a linear path for water to flow through. The second flow passage 310 is surrounded by the lateral wall 130 of the electrolysis stage 300. The lateral wall 130 of the electrolysis stage 300 serves as a mounting point for the electrolysis unit 320. The electrolysis unit 320 is positioned between the first flanged end 110 and the second flanged end 120 of the electrolysis stage 300 with a bias towards the second flanged end 120 of the electrolysis stage 300. Referencing FIG. 1-4 and FIG. 8-10, the three ports 330 are visible traversing through the lateral wall 130 of the electrolysis unit 320. The three ports 330 are provided as electrical connection ports for providing power to the electrolysis unit 320. It should be noted that in additional configurations of the present invention, the function of the electrical connection ports can be accomplished by alternative connections means. The electrolysis unit 320 traverses across the second flow passage 310, wherein the electrolysis unit 320 spans the width of the second flow passage 310. The positioning of the electrolysis unit 320 ensures interaction with the flow of water passing through the second flow passage 310.

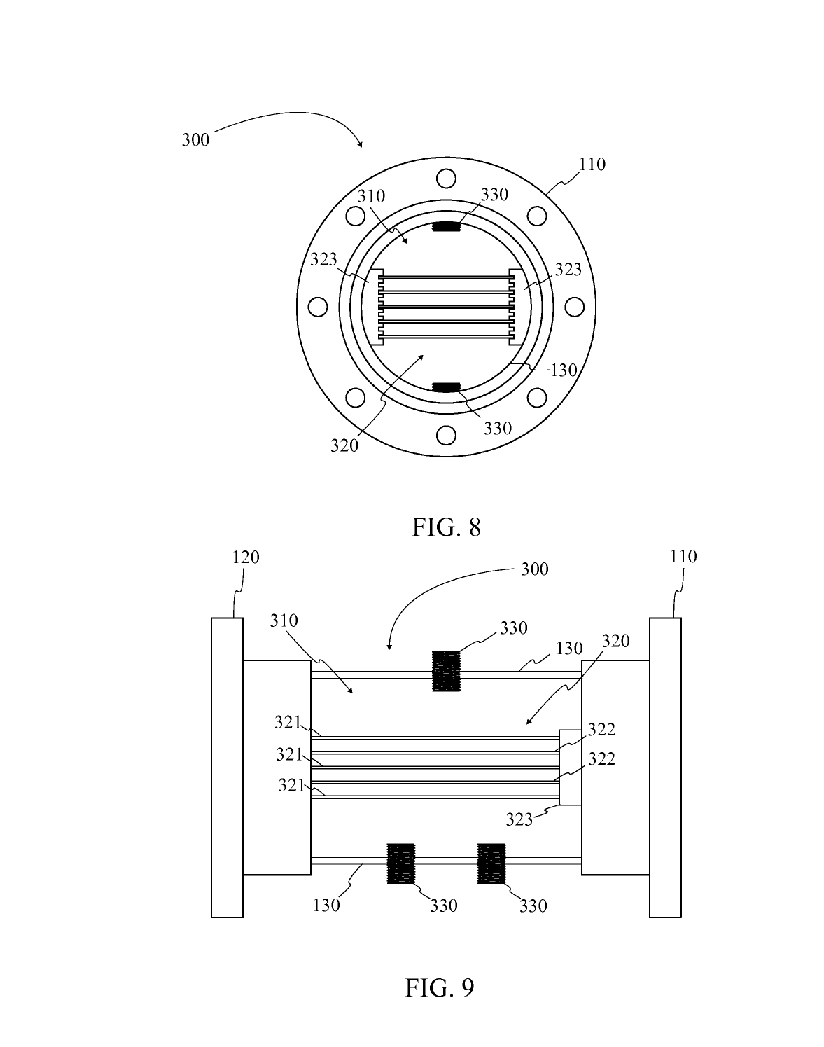

Referencing FIG. 8-10, the electrolysis unit 320 is the functional component of the electrolysis stage 300 that generates chlorine gas from dissolved chloride ions in the passing flow of water. In the current embodiment of the present invention, the electrolysis unit 320 comprises at least one anode plate 321, at least one cathode plate 322, and at least two plate mounts 323. The at least one anode plate 321 is the anodic electrode in the electrolysis unit 320 where a positive polarity is formed. The at least one cathode plate 322 is the cathodic electrode in the electrolysis unit 320 where a negative polarity is applied. The at least one anode plate 321 is positioned parallel to the at least one cathode plate 322 in order to generate an electrolytic cell when current is applied. The electrolytic cell reduces chloride ion in the passing flow of water generating chlorine gas. The at least one anode plate 321 and the at least one cathode plate 322 are electrically coupled to the at least two plate mounts 323. The electrical coupling provides the at least one anode plate 321 and the at least one cathode plate 322 with the power needed to generate an electrolytic cell. The at least two plate mounts 323 are oppositely positioned mountings securely emplaced on the lateral wall 130 of the electrolysis stage 300. The at least two plate mounts 323 ensure a secure placement for the at least one anode plate 321 and the at least one cathode plate 322, while additionally ensuring the parallel arrangement between the opposing electrodes. The at least one anode plate 321 and the at least one cathode plate 322 traverse across the second flow passage 310 in order to ensure the electrolytic cell they generate interacts with sufficient volume of the flow of water passing through the second flow passage 310. It should be noted that the electrolytic cell reduces chloride ions forming chlorine gas from dissolved sodium chlorides in the flow of passing water through the second flow passage 310.

In an embodiment of the present invention, water flows from the irradiation stage 200 into the electrolysis stage 300. Irradiated water flowing from the irradiation stage 200 into the electrolysis stage 300 contains chloride ions in an excited state. The excited state of the chloride ions is due to the photoelectric effects of UV radiation. The excited state of the chloride ions facilitates reduction into chlorine gas by the electrolytic cell formed by the electrolysis unit 320.

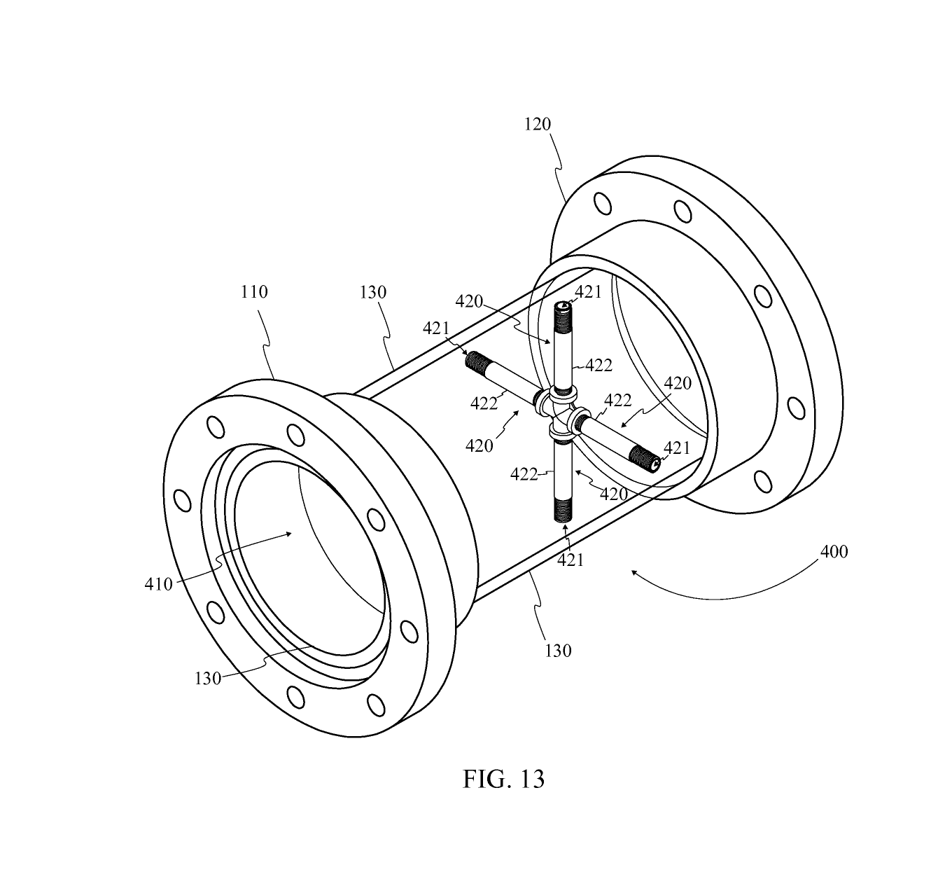

Referencing FIG. 1-4 and FIG. 11-13, the chemical injection stage 400 introduces chemical agents into the passing water flow that can function as oxidizers as well as disinfectants that and/or enhance the effectiveness of the irradiation stage 200 and the electrolysis stage 300. In the current embodiment of the present invention, the chemical injection stage 400 comprises a first flanged end 110, a second flanged end 120, a lateral wall 130, a third flow passage 410, and at least one chemical injection unit 420. The first flanged end 110 and the second flanged end 120 of the chemical injection stage 400 are oppositely positioned to one another across the lateral wall 130 of the chemical injection stage 400. Similar to the other stages, the first flanged end 110 and the second flanged end 120 of the chemical injection stage 400 are centrally aligned with the lateral wall 130 of the chemical injection stage 400. The third flow passage 410 is positioned along the central alignment forming a linear path for water to flow through. The third flow passage 410 is surrounded by the lateral wall 130 of the chemical injection stage 400. The at least on chemical injection unit 420 is partially positioned through the lateral wall 130 of the chemical injection stage 400. The partial positioning provides the at least one chemical injection unit 420 with a secure mounting point to the lateral wall 130 of the chemical injection stage 400. The at least one chemical injection unit 420 is positioned between the first flanged end 110 and the second flanged end 120 of the chemical injection stage 400 with a bias towards the second flanged end 120 of chemical injection stage 400. The at least one chemical injection unit 420 is disposed within the third flow passage 410. The disposed positioning of the at least one chemical injection unit 420 facilitates dispersal of a chemical agent into the flow of water passing through the third flow passage 410. The at least one chemical injection unit 420 is in fluid communication with the third flow passage 410, wherein the component positioning of the at least one chemical injection unit 420 provides enables the delivery of a chemical agent through the at least one chemical injection unit 420 and into the third flow passage 410.

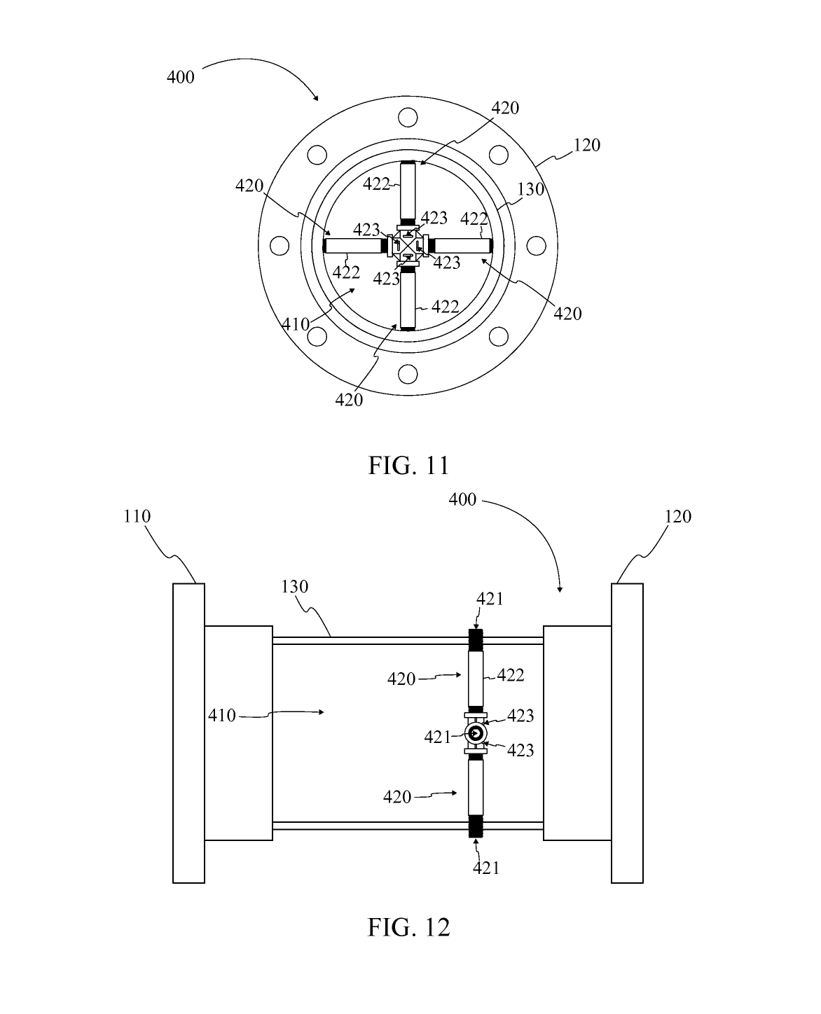

Referencing FIG. 11-13, the chemical injection unit 420 is the functional component of the chemical injection stage 400. The at least one chemical injection unit 420 serves as a conduit for introducing chemical agents into the third flow passage 410. In the current embodiment of the present invention the chemical injection unit 420 comprises an injection port 421, an injection channel 422, and at least one ejection port 423. The injection port 421 is found in fluid communication with the at least one ejection port 423 by way of the injection channel 422. The injection port 421 is the entrance point where a chemical agent enters the at least one chemical injection unit 420 in order to be introduced into the third flow channel. The injection channel 422 is the conduit that transports the chemical agent from the injection port 421 to the at least one ejection port 423. The injection channel 422 is disposed into the third flow passage 410 extending from the lateral wall 130 of the chemical injection stage 400. The at least one ejection port 423 serves as the exit point for a chemical agent that is being introduced into the third flow passage 410. The at least one ejection port 423 is found in fluid communication with the third flow passage 410, wherein the at least one ejection port 423 is particularly configured to use the fluid movement of water passing through the third flow passage 410 to facilitate delivery of a chemical agent. It should be noted that the at least one chemical injection unit 420 would likely include a valve mechanism within the injection channel 422 to prevent back flow. Alternatively, a chemical agent could be actively pumped into the third flow passage 410 preventing back flow up through the at least one chemical injection unit 420. It should be noted that the at least one chemical injection unit 420 is able to inject a plurality of chemical agents regardless of their state of matter.

In an embodiment of the invention, the at least one chemical injection unit 420 is an ozone injection unit. The ozone injection unit is particularly configured to deliver ozone gas into the third flow passage 410. Ozone is an extremely effective biocidal agent that has a high oxidation potential permitting it to react with a wider range of biological contaminants when compared to chlorine.

In an embodiment of the invention, the at least one chemical injection unit 420 is a chlorine dioxide injection unit. The chlorine dioxide unit is particularly configured to deliver chlorine dioxide into the third flow passage 410. Chlorine dioxide is an extremely effective biocidal agent that maintains long term efficiency at stopping microbial growth in treated water.

Referencing FIG. 1-4, in an embodiment of the present invention, water flows from the electrolysis stage 300 into the chemical injection stage 400. Electrolytically chlorinated water flowing from the electrolysis stage 300 into the chemical injection stage 400 contains reduced chlorine in gaseous form as a biocidal agent. In the embodiment of the invention where the at least one chemical injection unit 420 is configured as an ozone injection unit, the introduction of ozone cooperatively functions with chlorine to improve the biocidal performance of the water treatment system 100. In the embodiment of the invention where the at least on chemical injection unit 420 is configured as a chlorine dioxide injection unit, chlorine dioxide cooperatively function with chlorine to improve the long term efficiency of the water treatment system 100. Chlorine dioxide accomplishes the improvement in efficiency impart through its own biocidal effects as well as by reacting with by-products of electrolytic chlorination. Chlorine dioxide reduces by-products of electrolytic chlorination and forms chlorite ions increasing the presence of chlorine gas within the flow of water.

Referencing FIG. 1-4, in the preferred embodiment of the present invention, the irradiation stage 200, the electrolysis stage 300, and the chemical injection stage 400 are particularly arranged in order to enhance the functionality of the water treatment system 100. The second flanged end 120 of the electrolysis stage 300 is coincidently engaged to the first flanged end 110 of the irradiation stage 200. The aforementioned engagement provides irradiated water from the irradiation stage 200 containing chloride ions in an excited state to the electrolysis unit 320 in the second flow passage 310. The exited chloride ions improve the yield of chlorine production through electrolytic chlorination. The second flanged end 120 of the electrolysis stage 300 is coincidently engaged to the first flanged end 110 of the chemical injection stage 400. The aforementioned arrangement provides chlorine gas dissolved in the water from the second flow passage 310 for interaction with the at least one chemical injection unit 420. The at least one chemical injection unit 420 can be configured as an ozone injection unit and/or as a chlorine dioxide injection unit. When the at least one chemical injection unit 420 is configured as an ozone injection unit, ozone is introduced into the third flow passage 410 and mixes with the chlorinated water. The resulting ozone chlorine mixture uses the biocidal properties of each agent constructively to enhance the efficiency of the water treatment system 100. When the at least one chemical injection unit 420 is configured as a chlorine dioxide injection unit, chlorine dioxide is introduced into the third flow passage 410 and dissolves in the chlorinated water. The resulting mixture of the chlorine dioxide in the chlorinated water serves a dual purpose, firstly as an effective biocidal agent and secondly as stabilizing compound that reduces the reactivity of by-products of electrolytic chlorination. By reacting with by-products of electrolytic chlorination, chlorine dioxide prolongs the presence of chlorine gas in treated water. It should be noted that both configurations of the at least one chemical injection unit 420 may be provided simultaneously resulting in an ozone, chlorine dioxide, and chlorine mixture which significantly enhances the biocidal efficiency of the water treatment system 100. After water passes through the water treatment system 100, the treated water would be allowed a contact time to ensure biological containments are neutralized. Contact time can be provided by allowing the treated water to sit within the transfer lines or a holding tanks until sufficient time has passed.

The water treatment system 100 comprises an irradiation stage 200, an electrolysis stage 300, and a chemical injection stage 400 capable of injecting chlorine dioxide, ozone, or a combination of both as a means of eradicating biological containments.

The electrolysis stage 300 comprises an electrolysis unit 320 comprising five anode plates 321 and five cathode plates 322. The five anode plates 321 and the five cathode plates 322 are arranged in pairs as electrolysis plate sets comprising one anode plate 321 and one cathode plate 322. Each electrolysis plate set is electrically coupled to the at least two plate mounts 323 inside of the second flow passage 310. An electrical connection to the anode plate 321 and to the cathode plate 322 is provided through the at least two mounts. The electrical connection provided to the at least two plate mounts 323 is powered by a direct current power source. The at least two plate mounts 323 holding the electrolysis plate sets are constructed of an electrically insulating material.

The irradiation stage 200 comprises an UV irradiation unit 220 that extends downwardly within the enclosed space of the irradiation stage 200. The irradiation unit 220 comprises a UV bulb 221 positioned within a transparent quartz enclosure 222. The transparent quartz enclosure 222 houses the UV bulb 221 and provided with an impermeable construction. An electrical coupling is provided to power the UV bulb 221 but additionally provides a particular positioning for the transparent quartz enclosure 222 such that the UV bulb 221 and the transparent quartz enclosure 222 extend downwardly thru the first flow passage 210. An Electrical connection is provided to the electrical coupling in order to power the UV bulb 221 by the direct power source.

The lateral walls 130 of the irradiation stage 200, the electrolysis stage 300, and the chemical injection stage 400 can be constructed from Chlorinated polyvinyl chlorine (CPVC) that can be provided in either an opaque construction too block ultraviolet rays or a clear construction to allow viewing of the ozone and chlorine dioxide injection stages.

Although the invention has been explained in relation to its preferred embodiment, it is to be understood that many other possible modifications and variations can be made without departing from the spirit and scope of the invention as hereinafter claimed.

What is claimed is:

1. A water treatment system comprises:
an irradiation stage;
an electrolysis stage;
a chemical injection stage;
the irradiation stage, the electrolysis stage, and the chemical injection stage each comprise a first flanged end, a second flanged end, and a lateral wall;
the irradiation stage comprises a first flow passage and an ultraviolet irradiation unit;
the electrolysis stage comprises a second flow passage and an electrolysis unit;
the chemical injection stage comprises a third flow passage and at least one chemical injection unit;
the UV irradiation unit comprises at least one ultraviolet bulb and a transparent quartz enclosure;
the electrolysis unit comprises at least one anode plate, at least one cathode plate, and at least two plate mounts;
the at least one chemical injection unit comprises an injection port, an injection channel, and at least one ejection port;
the irradiation stage, the electrolysis stage, and the chemical injection stage being centrally aligned;
the irradiation stage, the electrolysis stage, and the chemical injection stage being sealed to one another, wherein the seal between the irradiation stage, the electrolysis stage, and the chemical injection stage is a water tight seal;
the irradiation stage, the electrolysis stage, and the chemical injection stage being detachably coupled to one another;
the first flow passage, the second flow passage, and the third flow passage being in operatively aligned with one another, wherein the operative alignment additionally provides fluid communication between the first flow passage, the second flow passage, and the third flow passage;
the first flanged end being oppositely positioned to the second flanged end across the lateral wall; and
the first flanged end and the second flanged end being centrally aligned with the lateral wall.

2. The water treatment system as claimed in claim 1 comprises:
the second flanged end of the irradiation unit being coincidentally engaged to the first flanged end of electrolysis stage;
the second flanged end of the electrolysis stage being coincidentally engaged to the first flanged end of the chemical injection stage; and
the second flow passage being positioned between the first flow passage and the third flow passage.

3. The water treatment system as claimed in claim 1 comprises:
the first flow passage being surrounded by the lateral wall of the irradiation stage;
the first flow passage being centrally positioned to the first flanged end of the irradiation stage and the second flanged end of the irradiation stage;
the UV irradiation unit being positioned between the first flanged end of the irradiation stage and the second flanged end of the irradiation stage;
the UV irradiation unit traverses into the first flow passage by way of the lateral wall of the irradiation stage; and
the UV irradiation unit being optically disposed with the first flow passage.

4. The water treatment system as claimed in claim 3 comprises:
the transparent quartz enclosure being angularly positioned to the lateral wall of the irradiation stage, wherein the transparent quartz enclosure extends towards the second flanged end of the irradiation stage;
the at least one ultraviolet bulb being surrounded by the transparent quartz enclosure;

5. The water treatment system as claimed in claim 1 comprises:
the second flow passage being surrounded by the lateral wall of the electrolysis stage;
the second flow passage being centrally positioned to the first flanged end of the electrolysis stage and the second flanged end of the electrolysis stage;
the electrolysis unit being positioned between the first flanged end of the electrolysis stage and the second flanged end of the electrolysis stage;
the electrolysis unit being mounted to the lateral wall of the electrolysis stage; and
the electrolysis unit traverses across the second flow passage.

6. The water treatment system as claimed in claim 5 comprises:
the at least two plate mounts being oppositely positioned across the second flow passage;
the at least two plate mounts being securely emplaced on the lateral wall of the electrolysis stage;
the at least one anode plate and the at least one cathode plate being electrically coupled to the at least two plate mounts; and
the at least one anode plate and the at least one cathode plate traverse across the second flow passage.

7. The water treatment system as claimed in claim 1 comprises:
the third flow passage being surrounded by the lateral wall of the chemical injection stage;
the third flow passage being centrally positioned to the first flanged end of the chemical injection stage and the second flanged end of the chemical injection stage;
the at least one chemical injection unit being positioned between the first flanged end of the chemical injection stage and the second flanged end of the chemical injection stage;
the at least one chemical injection unit partially traverses the lateral wall of the chemical injection stage;
the at least one chemical injection unit being the securely mounted to lateral wall of the chemical injection stage;
the at least one chemical injection unit being disposed within the third flow passage; and
the at least one chemical injection unit being in fluid communication with the third flow passage.

8. The water treatment system as claimed in claim 7 comprises:
the injection port being in fluid communication with the at least one ejection port by way of the injection channel;
the injection port being peripherally positioned to the lateral wall of the chemical injection stage;
the injection channel being disposed into the third flow passage from the lateral wall of the chemical injection stage; and
the at least one ejection port being in fluid communication within the third flow passage way.

9. The at least one chemical injection unit as claimed in claim 7 is an ozone injection unit.

10. The at least one chemical injection unit as claimed in claim 7 is a chlorine dioxide injection unit.

11. A water treatment system comprises:
an irradiation stage;
an electrolysis stage;
a chemical injection stage;
the irradiation stage, the electrolysis stage, and the chemical injection stage each comprise a first flanged end, a second flanged end, and a lateral wall;
the irradiation stage comprises a first flow passage and an ultraviolet irradiation unit;
the electrolysis stage comprises a second flow passage and an electrolysis unit;
the chemical injection stage comprises a third flow passage and at least one chemical injection unit;
the UV irradiation unit comprises at least one ultraviolet bulb and a transparent quartz enclosure;
the electrolysis unit comprises at least one anode plate, at least one cathode plate, and at least two plate mounts;
the at least one chemical injection unit comprises an injection port, an injection channel, and at least one ejection port;
the irradiation stage, the electrolysis stage, and the chemical injection stage being centrally aligned;
the irradiation stage, the electrolysis stage, and the chemical injection stage being sealed to one another, wherein the seal between the irradiation stage, the electrolysis stage, and the chemical injection stage is a water tight seal;
the irradiation stage, the electrolysis stage, and the chemical injection stage being detachably coupled to one another;
the first flow passage, the second flow passage, and the third flow passage being in operatively aligned with one another, wherein the operative alignment additionally provides fluid communication between the first flow passage, the second flow passage, and the third flow passage;
the first flanged end being oppositely positioned to the second flanged end across the lateral wall;
the first flanged end and the second flanged end being centrally aligned with the lateral wall;
the second flanged end of the irradiation unit being coincidentally engaged to the first flanged end of electrolysis stage;
the second flanged end of the electrolysis stage being coincidentally engaged to the first flanged end of the chemical injection stage; and
the second flow passage being positioned between the first flow passage and the third flow passage.

12. The water treatment system as claimed in claim 11 comprises:
the first flow passage being surrounded by the lateral wall of the irradiation stage;
the first flow passage being centrally positioned to the first flanged end of the irradiation stage and the second flanged end of the irradiation stage;
the UV irradiation unit being positioned between the first flanged end of the irradiation stage and the second flanged end of the irradiation stage;
the UV irradiation unit traverses into the first flow passage by way of the lateral wall of the irradiation stage;
the UV irradiation unit being optically disposed with the first flow passage;
the transparent quartz enclosure being angularly positioned to the lateral wall of the irradiation stage, wherein the transparent quartz enclosure extends towards the second flanged end of the irradiation stage; and
the at least one ultraviolet bulb being surrounded by the transparent quartz enclosure.

13. The water treatment system as claimed in claim 11 comprises:
the second flow passage being surrounded by the lateral wall of the electrolysis stage;
the second flow passage being centrally positioned to the first flanged end of the electrolysis stage and the second flanged end of the electrolysis stage;
the electrolysis unit being positioned between the first flanged end of the electrolysis stage and the second flanged end of the electrolysis stage;
the electrolysis unit being mounted to the lateral wall of the electrolysis stage;
the electrolysis unit traverses across the second flow passage;
the at least two plate mounts being oppositely positioned across the second flow passage;
the at least two plate mounts being securely emplaced on the lateral wall of the electrolysis stage;
the at least one anode plate and the at least one cathode plate being electrically coupled to the at least two plate mounts; and
the at least one anode plate and the at least one cathode plate traverse across the second flow passage.

14. The water treatment system as claimed in claim 11 comprises:
the third flow passage being surrounded by the lateral wall of the chemical injection stage;
the third flow passage being centrally positioned to the first flanged end of the chemical injection stage and the second flanged end of the chemical injection stage;
the at least one chemical injection unit being positioned between the first flanged end of the chemical injection stage and the second flanged end of the chemical injection stage;
the at least one chemical injection unit partially traverses the lateral wall of the chemical injection stage;
the at least one chemical injection unit being the securely mounted to lateral wall of the chemical injection stage;
the at least one chemical injection unit being disposed within the third flow passage;
the at least one chemical injection unit being in fluid communication with the third flow passage;
the injection port being in fluid communication with the at least one ejection port by way of the injection channel;
the injection port being peripherally positioned to the lateral wall of the chemical injection stage;
the injection channel being disposed into the third flow passage from the lateral wall of the chemical injection stage; and
the at least one ejection port being in fluid communication within the third flow passage way.

15. The at least one chemical injection unit as claimed in claim 14 is an ozone injection unit.

16. The at least one chemical injection unit as claimed in claim 14 is a chlorine dioxide injection unit.

17. A water treatment system comprises:
an irradiation stage;
an electrolysis stage;
a chemical injection stage;
the irradiation stage, the electrolysis stage, and the chemical injection stage each comprise a first flanged end, a second flanged end, and a lateral wall;
the irradiation stage comprises a first flow passage and an ultraviolet irradiation unit;
the electrolysis stage comprises a second flow passage and an electrolysis unit;
the chemical injection stage comprises a third flow passage and at least one chemical injection unit;
the UV irradiation unit comprises at least one ultraviolet bulb and a transparent quartz enclosure;
the electrolysis unit comprises at least one anode plate, at least one cathode plate, and at least two plate mounts;
the at least one chemical injection unit comprises an injection port, an injection channel, and at least one ejection port;
the irradiation stage, the electrolysis stage, and the chemical injection stage being centrally aligned;
the irradiation stage, the electrolysis stage, and the chemical injection stage being sealed to one another, wherein the seal between the irradiation stage, the electrolysis stage, and the chemical injection stage is a water tight seal;
the irradiation stage, the electrolysis stage, and the chemical injection stage being detachably coupled to one another;
the first flow passage, the second flow passage, and the third flow passage being in operatively aligned with one another, wherein the operative alignment additionally provides fluid communication between the first flow passage, the second flow passage, and the third flow passage;
the first flanged end being oppositely positioned to the second flanged end across the lateral wall;
the first flanged end and the second flanged end being centrally aligned with the lateral wall;
the second flanged end of the irradiation unit being coincidentally engaged to the first flanged end of electrolysis stage;
the second flanged end of the electrolysis stage being coincidentally engaged to the first flanged end of the chemical injection stage;
the second flow passage being positioned between the first flow passage and the third flow passage;
the first flow passage being surrounded by the lateral wall of the irradiation stage;
the first flow passage being centrally positioned to the first flanged end of the irradiation stage and the second flanged end of the irradiation stage;
the UV irradiation unit being positioned between the first flanged end of the irradiation stage and the second flanged end of the irradiation stage;
the UV irradiation unit traverses into the first flow passage by way of the lateral wall of the irradiation stage;
the UV irradiation unit being optically disposed with the first flow passage;
the transparent quartz enclosure being angularly positioned to the lateral wall of the irradiation stage, wherein the transparent quartz enclosure extends towards the second flanged end of the irradiation stage;
the at least one ultraviolet bulb being surrounded by the transparent quartz enclosure;
the second flow passage being surrounded by the lateral wall of the electrolysis stage;
the second flow passage being centrally positioned to the first flanged end of the electrolysis stage and the second flanged end of the electrolysis stage;
the electrolysis unit being positioned between the first flanged end of the electrolysis stage and the second flanged end of the electrolysis stage;
the electrolysis unit being mounted to the lateral wall of the electrolysis stage;
the electrolysis unit traverses across the second flow passage;
the at least two plate mounts being oppositely positioned across the second flow passage;
the at least two plate mounts being securely emplaced on the lateral wall of the electrolysis stage;
the at least one anode plate and the at least one cathode plate being electrically coupled to the at least two plate mounts;
the at least one anode plate and the at least one cathode plate traverse across the second flow passage;
the third flow passage being surrounded by the lateral wall of the chemical injection stage;
the third flow passage being centrally positioned to the first flanged end of the chemical injection stage and the second flanged end of the chemical injection stage;
the at least one chemical injection unit being positioned between the first flanged end of the chemical injection stage and the second flanged end of the chemical injection stage;
the at least one chemical injection unit partially traverses the lateral wall of the chemical injection stage;
the at least one chemical injection unit being the securely mounted to lateral wall of the chemical injection stage;
the at least one chemical injection unit being disposed within the third flow passage;
the at least one chemical injection unit being in fluid communication with the third flow passage;
the injection port being in fluid communication with the at least one ejection port by way of the injection channel;
the injection port being peripherally positioned to the lateral wall of the chemical injection stage;
the injection channel being disposed into the third flow passage from the lateral wall of the chemical injection stage; and
the at least one ejection port being in fluid communication within the third flow passage way.

18. The at least one chemical injection unit as claimed in claim 17 is an ozone injection unit.

19. The at least one chemical injection unit as claimed in claim 17 is a chlorine dioxide injection unit.
